(19) United States
(12) Patent Application Publication
(10) Pub. No.: US 2018/0009536 A1
(43) Pub. Date: Jan. 11, 2018

(54) BLEED FLOW EXTRACTION SYSTEM FOR A GAS TURBINE ENGINE

(71) Applicant: General Electric Company, Schenectady, NY (US)

(72) Inventors: Charles Kammer Christopherson, Andover, MA (US); Brandon Wayne Miller, Liberty Township, OH (US)

(21) Appl. No.: 15/206,663

(22) Filed: Jul. 11, 2016

(51) Int. Cl. B64D 13/06; F02C 6/08; F02C 3/04; F01D 17/14; F02C 9/18; B64D 13/02; H02K 7/18; F01D 15/10

(52) U.S. Cl. CPC B64D 13/06; H02K 7/1823; F02C 6/08; F01D 15/10; F01D 17/145; F02C 9/18; B64D 13/02; F02C 3/04; B64D 2013/0603; F05D 2220/323; F05D 2220/76

(57) ABSTRACT

An air cycle machine for extracting bleed air from a gas turbine engine of an aircraft is provided. The air cycle machine extracts a stream of low pressure bleed air and a stream of high pressure bleed air from a compressor section of the gas turbine engine. The air cycle machine includes a compressor that receives the stream of low pressure bleed air and a turbine that receives the stream of high pressure bleed air. The stream of high pressure bleed air is expanded as it drives the turbine, and the stream of low pressure bleed air is compressed by the compressor. The resulting streams of bleed air are substantially the same pressure, such that they may be merged using a junction into a combined bleed air stream having a temperature and pressure suitable for use by a variety of aircraft accessory systems, such as an environmental control system. The air cycle machine may further power or be powered from an electrical storage device or generator on the fan.

### FIELD OF THE INVENTION

The present subject matter relates generally to gas turbine engines, and more specifically, to utilization of gas turbine engine bleed air to supply aircraft environmental control systems.

### BACKGROUND OF THE INVENTION

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

Conventional aircraft often use bleed air, i.e., regulated airflow extracted from the gas turbine engine, as supply air for various accessory systems of the aircraft. For example, bleed air is commonly extracted from the low pressure compressor (LPC) and/or the high pressure compressor (HPC) section of a gas turbine engine and used as supply air for the environmental control system (ECS) of the aircraft. Environmental control systems are used to condition air for the cabin and crew as well as providing cooling for avionics and/or other equipment needing cooling.

However, bleed air is often at a higher temperature and pressure than needed for the accessory system it is powering. Therefore, for example, an environmental control system may incorporate various pieces of equipment such as air cycle machines (ACMs), regulating valves, heat exchangers, and other apparatus to condition engine bleed air prior to cabin introduction. For example, check valves may be used to allow or discontinue airflow, regulator valves may be used to restrict airflow and reduce the pressure of the bleed air before it reaches the ECS, and a precooler may be used to help regulate the temperature and pressure of the bleed air. These bleed air regulating and conditioning systems add costs, require additional space, require separate power sources, and are otherwise detrimental to the efficiency of the gas turbine engine.

Accordingly, a gas turbine engine with features for more efficiently utilizing bleed air from a compressor section of the gas turbine engine would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure a gas turbine engine assembly for an aircraft is provided. The gas turbine engine assembly includes a core engine including a compressor section, the compressor section defining a low pressure bleed port for extracting a first stream of bleed air and a high pressure bleed port for extracting a second stream of bleed air. The gas turbine engine assembly further includes an air cycle machine configured for providing bleed air to an accessory system of the aircraft. The air cycle machine includes a turbine in fluid communication with the high pressure bleed port for receiving the second stream of bleed air and a compressor in fluid communication with the low pressure bleed port for receiving the first stream of bleed air. The turbine expands the second stream of bleed air such that the second stream of bleed air rotates the turbine. The compressor is mechanically coupled to the turbine by a shaft such that the turbine drives the compressor and increases a pressure of the first stream of bleed air. A junction is in fluid communication with both the turbine and the compressor, the junction being configured to combine the first stream of bleed air from the compressor and the second stream of bleed air from the turbine into a combined bleed air stream to be supplied to the accessory system.

In another exemplary embodiment of the present disclosure, an air cycle machine for extracting bleed air from a gas turbine engine of an aircraft is provided. The gas turbine engine includes a compressor section, the compressor section defining a low pressure bleed port for extracting a first stream of bleed air and a high pressure bleed port for extracting a second stream of bleed air. The air cycle machine includes a compressor in fluid communication with the low pressure bleed port for receiving a first stream of bleed air and compressing the first stream of bleed air and a turbine in fluid communication with the high pressure bleed port for receiving a second stream of bleed air and expanding the second stream of bleed air to rotate the turbine. A shaft mechanically couples the turbine to the compressor, such that rotation of the turbine drives the compressor. A junction is in fluid communication with both the compressor and the turbine, the junction being configured to combine the first stream of bleed air from the compressor and the second stream of bleed air from the turbine into a combined bleed air stream to be supplied to an accessory system of the aircraft.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic cross-sectional view of an exemplary gas turbine engine according to various embodiments of the present subject matter.

FIG. 2 provides a schematic representation of a gas turbine engine including an air cycle machine according to an exemplary embodiment of the present subject matter.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

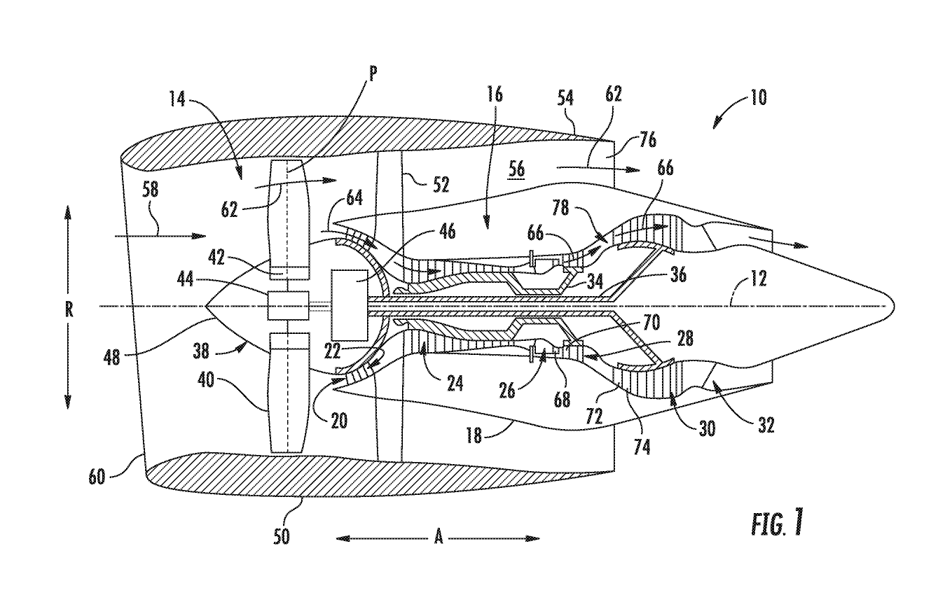

Referring now to the drawings, wherein identical numerals indicate the same elements throughout the figures, FIG. 1 is a schematic cross-sectional view of a turbomachine in accordance with an exemplary embodiment of the present disclosure. More particularly, for the embodiment of FIG. 1, the turbomachine is configured as a gas turbine engine, or rather as a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (not shown) extending about the longitudinal centerline 12. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases and the core turbine engine 16 includes, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. Accordingly, the LP shaft 36 and HP shaft 34 are each rotary components, rotating about the axial direction A during operation of the turbofan engine 10.

Referring still to the embodiment of FIG. 1, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40 in unison. The fan blades 40, disk 42, and pitch change mechanism 44 are together rotatable about the longitudinal axis 12 by LP shaft 36 across a power gear box 46. The power gear box 46 includes a plurality of gears for adjusting the rotational speed of the fan 38 relative to the LP shaft 36 to a more efficient rotational fan speed. More particularly, the fan section includes a fan shaft rotatable by the LP shaft 36 across the power gearbox 46. Accordingly, the fan shaft may also be considered a rotary component, and is similarly supported by one or more bearings.

Referring still to the exemplary embodiment of FIG. 1, the disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. The exemplary nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is increased in pressure and is directed or routed into the bypass airflow passage 56 and a second portion of the air 58 as indicated by arrow 64 is increased in pressure and is directed or routed into the core air flowpath, or more specifically into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is provided by way of example only, and that in other exemplary embodiments, the turbofan engine 10 may have any other suitable configuration. It should also be appreciated, that in still other exemplary embodiments, aspects of the present disclosure may be incorporated into any other suitable gas turbine engine. For example, in other exemplary embodiments, aspects of the present disclosure may be incorporated into, e.g., a turboprop engine, a turboshaft engine, or a turbojet engine. Further, in still other embodiments, aspects of the present disclosure may be incorporated into any other suitable turbomachine, including, without limitation, a steam turbine, a centrifugal compressor, and/or a turbocharger.

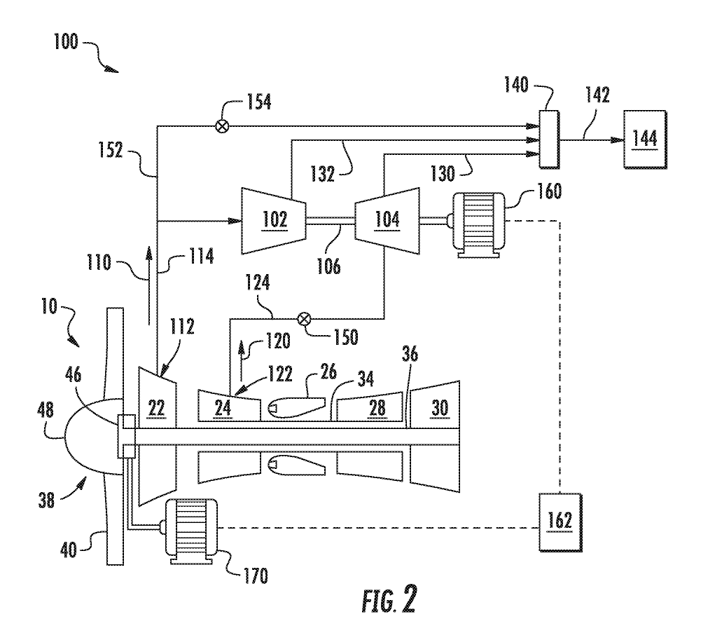

Referring now to FIG. 2, a schematic representation of turbofan engine 10 and an air cycle machine 100 according to an exemplary embodiment of the present subject matter is provided. Although air cycle machine 100 is described below as being utilized to extract bleed air from turbofan engine 10, one skilled in the art will appreciate that this is only an exemplary embodiment used for illustrative purposes. Air cycle machine 100 may be modified and such modifications may be within the scope of the present subject matter. In addition, air cycle machine 100 may be configured for use in other applications, such as other gas turbine engines or any other suitable application where bleed air from an engine is used to drive an accessory system.

As illustrated, air cycle machine 100 generally includes a compressor 102 and a turbine 104 mechanically coupled by a shaft 106. According to the exemplary embodiment, shaft 106 directly couples compressor 102 and turbine 104, such that they rotate at the same speed. However, according to alternative embodiments, any suitable operational coupling may be employed to couple compressor 102 to turbine 104, such as a suitable gear arrangement or gear box having a desired gear ratio.

Air cycle machine 100 is plumbed to receive bleed air from multiple stages of the compressor section of turbofan engine 10. More specifically, according to the illustrated exemplary embodiment, a first stream of bleed air (e.g., low pressure bleed air as indicated by arrow 110) may be extracted from LP compressor 22 through a LP bleed port 112. Low pressure bleed air 110 may be supplied to compressor 102 via a low pressure bleed line 114, which may be, for example, any suitable tubing that places LP bleed port 112 in fluid communication with compressor 102.

Similarly, a second stream of bleed air (e.g., high pressure bleed air as indicated by arrow 120) may be extracted from HP compressor 24 through a HP bleed port 122. High pressure bleed air 120 may be supplied to turbine 104 via a high pressure bleed line 124, which may be, for example, any suitable tubing that places HP bleed port 122 in fluid communication with turbine 104.

Although bleed air is described above as being supplied to compressor 102 and turbine 104 by bleed lines 114, 124 directly from the LP and HP compressors 22, 24, one skilled in the art will appreciate that any suitable means for supplying bleed air to air cycle machine 100 may be used, and the bleed air may be extracted from any suitably pressurized portion of turbofan engine 10. For example, as described above, each of LP compressor 22 and HP compressor 24 include sequential stages of stator vanes and rotor blades which progressively increase the pressure of air flowing through core turbine engine 16. Bleed air may be drawn from any two locations along either compressor section, e.g., bleed ports 112, 122 may both be positioned on the LP compressor 22 or HP compressor 24. Indeed, one skilled in the art will appreciate that bleed air drawn from more than two locations in the compressor section and may be utilized to drive air cycle machine 100, e.g., by merging or combining streams of bleed air, selectively utilizing streams of bleed air, etc.

In general, air cycle machine 100 operates by mixing multiple stages of bleed air and exhausts both streams through a common exit. For example, according to the illustrated embodiment, high pressure bleed air 120 is supplied to turbine 104. High pressure bleed air 120 is passed through turbine 104, where it expands as it rotates turbine 104. Rotating turbine 104 drives compressor 102 via shaft 106. Notably, high pressure bleed air 120 exits turbine 104 through a turbine outlet line 130 at a lower pressure than when it was extracted from HP compressor 24 via high pressure bleed port 122.

Simultaneously, low pressure bleed air 110 is supplied to compressor 102, where it is compressed, before exiting compressor 102 through a compressor outlet line 132. Notably, low pressure bleed air 110 exits compressor 102 at a higher pressure than when it was extracted from LP compressor 22 via low pressure bleed port 112. According to an exemplary embodiment, low pressure bleed air 110 and high pressure bleed air 120 are substantially the same pressure as after passing through air cycle machine 100.

Notably, prior to passing low pressure bleed air 110 and high pressure bleed air 120 through air cycle machine 100, their respective pressures were so different that the two streams could not be mixed without the use of an ejector or similar device to facilitate merging the streams. However, after the pressure of low pressure bleed air 110 has been increased and the pressure of high pressure bleed air 120 has been decreased, the two streams may be merged without an ejector, e.g., using a junction 140.

Junction 140 may simply be a mixing manifold having two or more inlets for receiving bleed air and one or more outlets for supplying that bleed air to accessory systems of the aircraft. A variety of control valves and regulating valves may be used to selectively distribute air from junction 140 between various accessory systems of the aircraft. For example, as illustrated in FIG. 2, junction 140 is configured to receive low pressure bleed air 110 (after being compressed in compressor 102) and high pressure bleed air 120 (after being expanded in turbine 104), merge the two streams into a combined stream of bleed air, and supply the combined stream through a supply line 142 to an environmental control system (ECS) 144 of the aircraft.

Air cycle machine 100 may include a variety of valves, regulators, and other suitable apparatus for controlling the flow of bleed air within air cycle machine 100. For example, according to the illustrated exemplary embodiment of FIG. 2, air cycle machine 100 includes a high pressure regulating valve 150 that is operably coupled to high pressure bleed line 124. Regulating valve 150 is configured to control the flow of high pressure bleed air 120 to turbine 104. By controlling this flow, regulating valve 150 may be used to control the overall air flow rate (i.e., the combination of bleed air streams 110, 120) based on the demand of the environmental control system 144 and/or a pressure of the airflow at low pressure bleed port 112 and high pressure bleed port 122. A check valve in the compressor outlet line 132 may be used to prevent high pressure air from back pressuring the low pressure compressor.

In addition, regulating valve 150 may be configured to stop flow completely through high pressure bleed line 124. In this manner, air cycle machine 100 stops passing high pressure bleed air 120 to turbine 104 and compressing low pressure bleed air 110 to pass to environmental control system 144. This may be desirable, for example, when turbofan engine 10 is operating at a power level such that the low pressure bleed air 110 has sufficient pressure to supply environmental control system 144 by itself, such as at a full power condition. To utilize low pressure bleed air 110 in such a situation, a bypass bleed line 152 may be configured for placing low pressure bleed port 112 in fluid communication with junction 140. For example, bypass bleed line 152 may be a conduit that directly couples low pressure bleed line 114 to junction 140.

A bypass valve 154 may be operably coupled to bypass bleed line 152 to control the flow of low pressure bleed air 110 through bypass bleed line 152. For example, by opening bypass valve 154 completely, low pressure bleed air 110 may flow directly through bypass bleed line 152 directly to junction 140. Low pressure bleed air 110 may also flow to junction 140 through compressor 102. However, by closing regulating valve 150 completely, high pressure bleed air 120 is not supplied to and does not drive turbine 104. Therefore, low pressure bleed air 110 is not further compressed and may be supplied directly from low pressure bleed port 112 to junction 140 and environmental control system 144.

One skilled in the art will appreciate that regulating valve 150 and bypass valve 154 need not be operated in only the open or closed positions. In addition, regulating valve 150 and bypass valve 154 may operate independently from each other to achieve the desired flow rates and pressures through air cycle machine 100. Indeed, according to an alternative embodiment regulating valve 150 may be used simultaneously with bypass valve 154, to adjust the overall ratio of bleed air providing from bleed ports 112, 122 as well as the amount of bleed air that is expanded and compressed using air cycle machine 100.

It should be appreciated that although two regulating valves are discussed above, air cycle machine 100 may include any number and variety of flow regulating devices to achieve the desired pressure and temperature of bleed air entering junction 140. For example, air cycle machine 100 may include an additional regulator valve coupled directly to low pressure bleed line 114 or downstream of air cycle machine 100. In addition, additional bleed lines may be included for extracting bleed air from the compressor section at various locations and the bleed lines may be selectively opened or closed to provide air cycle machine 100 with bleed air at the desired pressures depending on the application.

Work performed by high pressure bleed air 120 turning turbine 104 may be utilized to power other equipment associated with the turbofan engine 10 or the aircraft itself. For example, as illustrated in FIG. 2, the exemplary air cycle machine 100 depicted further includes an electrical motor-generator 160. Electrical motor-generator 160 is mechanically coupled to shaft 106 of air cycle machine 100. However, in other embodiments, electrical motor-generator 160 may be coupled to compressor 102 or turbine 104 using another suitable coupling mechanism. Electrical motor-generator 160 may operate by either extracting rotational energy from shaft 106 to generate electrical power or using electrical power to supply a motive force input to shaft 106 of air cycle machine 100. A power storage device 162 may be used to store energy generated by electrical motor-generator 160 or to supply electrical power for rotating electrical motor-generator 160 to drive air cycle machine 100. Power storage device 162 may be, for example, a battery bank, fuel cells, etc.

During use, an electrical current may be selectively transferred between electrical motor-generator 160 and power storage device 162. An exemplary embodiment of electrical motor-generator 160 includes an electromagnetic winding (not shown) wrapped about shaft 106. During use as a motor, an electrical current may be delivered to the electromagnetic winding, inducing a magnetic field that, in turn, generates a rotational motive force at shaft 106. When a separate motive force (i.e., a motive force originating outside of electrical motor-generator 160) is supplied to shaft 106, a magnetic field radially inward from the winding may generate or induce an output electrical current through the electromagnetic winding. The current may be further transferred to power storage device 162 as an electrical power output. Additionally or alternatively, the current may be transferred as an electrical power output to turbofan engine 10 or another component of the aircraft.

According to the illustrated exemplary embodiment of FIG. 2, fan 38 may be configured for generating electrical power that may be used, e.g., to drive air cycle machine 100. For example, as discussed above, fan 38 is operably coupled with power gearbox 46. As illustrated, power gearbox 46 is operably coupled with and configured to drive an electrical motor-generator 170. In certain conditions, such as descent conditions, the volume of intake air 58 entering turbofan engine 10 may actually drive the fan, as opposed to the LP shaft 36 driving fan 38 to draw in air. In such a situation, electrical energy may be generated from the rotational energy of the fan 38 using electrical motor-generator 170. That electrical energy may be stored in power storage device 162, or in another suitable energy storage device, in a manner similar to electrical energy from electrical motor-generator 160 and may be used to power accessory systems of the aircraft. Alternatively, the electrical power generated may be used to power air cycle machine 100 directly.

Notably, in prior configurations, a minimum requirement for high pressure bleed air for supplying an environmental control system may require the turbofan engine 10 to operate at a higher than necessary level (thrust-wise) to generate the necessary bleed air mass flow or pressure. Accordingly, the present configuration may allow the turbofan engine 10 to be operated at lower power levels during descent, as lower pressure bleed air may be compressed through air cycle machine 100 using the electrical energy extracted through the electrical motor-generator 170. This may be done by using compressor 102 to increase the low pressure bleed air 110 pressure or by electrically motoring turbine 104 in the opposite rotational direction to increase the high pressure bleed air 120 pressure.

In other engine operating conditions (namely high altitude, low power) the high pressure compressor bleed pressure may be below the required level requiring an increase in engine power level and fuel burn. Venting compressor outlet line 132 to ambient pressure will cause air cycle machine 100 to run in reverse, extracting power from the low pressure bleed (compressor 102 acts like a turbine) and increasing pressure of the high pressure bleed (turbine 104 acts like a compressor) allowing a reduction in power level and fuel burn.

In some embodiments, a controller (not shown) is provided to control one or more operational parameters of turbofan engine 10 and air cycle machine 100, e.g., to control one or more of regulating valve 150 and bypass valve 154. The controller may include one or more discrete processors, memory units, and power storage units (not pictured). The processor may also include a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. The processor may also include a microprocessor, or a combination of the aforementioned devices (e.g., a combination of a DSP and a microprocessor, a plurality of microprocessors, one or more microprocessors in conjunction with a DSP core, or any other such configuration).

Additionally, the memory device(s) may generally comprise memory element(s) including, but not limited to, computer readable medium (e.g., random access memory (RAM)), computer readable non-volatile medium (e.g., a NVRAM, flash memory, EEPROM, or FRAM), a compact disc-read only memory (CD-ROM), a magneto-optical disk (MOD), a digital versatile disc (DVD), and/or other suitable memory elements. The memory can store information accessible by the processor(s), including instructions that can be executed by the processor(s). For example, the instructions can be software or any set of instructions that, when executed by the processor(s), cause the processor(s) to perform operations. Optionally, the instructions may include a software package configured to operate air cycle machine 100 to, e.g., execute one or more operating methods.

Notably, there are limitations on the amount of bleed air that may be drawn from a single compressor stage. For example, extracting higher than 10% of the total air mass flow rate from single compressor stage may lead to operability concerns. The above-described subject matter provides a novel bleed system for a gas turbine engine that utilizes bleed air from multiple locations on the compressor section of the gas turbine engine. In this manner, the amount of air extracted from the compressor section may be increased. For example, by extracting bleed air at both the LP compressor 22 and the HP compressor 24, the total extracted mass flow rate may be doubled, e.g., to 20% of the overall mass flow rate of air flowing through core turbine engine 16. In addition, a mass flow rate of the combined bleed air stream may be approximately two times greater than the mass flow rate of a single air stream bleed system.

However, drawing bleed air from two locations on the compressor section results in two streams of air having different temperatures and pressures. Therefore, conventional bleed systems required additional equipment to mix the two streams, such as ejectors and a precooler. The proposed air cycle machine 100 extracts work from high pressure bleed air 120 passing through turbine 104 to compress low pressure bleed air 110 in compressor 102. Low pressure bleed air 110 (at increased pressure) and high pressure bleed air 120 (at decreased pressure) can then be mixed at the exit of air cycle machine 100 without the need for complicated or costly equipment. For example, the two streams may be merged by a simple junction or manifold.

In addition, according to an exemplary embodiment, the temperature of high pressure bleed air 120 exiting turbine 104 is lower than the temperature as it is extracted from high pressure bleed port 122. Moreover, high pressure bleed air 120 is mixed with low pressure bleed air 110, which is already has a lower temperature because it was extracted from an initial stage of the compressor section. When the streams are combined, the temperature may be low enough, e.g., less than 450 degrees Fahrenheit, to supply it directly to environmental control system 144 without the need to pass it through a precooler, as in prior systems. Eliminating the precooler saves costs, space, and energy which may advantageously be expended elsewhere within turbofan engine 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine assembly for an aircraft, the gas turbine engine assembly comprising:
a core engine comprising a compressor section, the compressor section defining a low pressure bleed port for extracting a first stream of bleed air and a high pressure bleed port for extracting a second stream of bleed air; and
an air cycle machine configured for providing bleed air to an accessory system of the aircraft, the air cycle machine comprising:
a turbine in fluid communication with the high pressure bleed port for receiving the second stream of bleed air, the turbine expanding the second stream of bleed air such that the second stream of bleed air rotates the turbine;
a compressor in fluid communication with the low pressure bleed port for receiving the first stream of bleed air, the compressor being mechanically coupled to the turbine by a shaft such that the turbine drives the compressor and increases a pressure of the first stream of bleed air; and
a junction in fluid communication with both the turbine and the compressor, the junction being configured to combine the first stream of bleed air from the compressor and the second stream of bleed air from the turbine into a combined bleed air stream to be supplied to the accessory system.

2. The gas turbine engine assembly of claim 1, wherein the air cycle machine further comprises:
a bypass bleed line configured for placing the low pressure bleed port in fluid communication with the junction; and
a bypass valve operably coupled to the bypass bleed line, the bypass valve configured to control the flow of the first stream of bleed air through the bypass bleed line to the junction.

3. The gas turbine engine assembly of claim 2, wherein the air cycle machine further comprises a high pressure regulating valve operably coupled to the high pressure bleed port, the high pressure regulating valve configured for controlling the flow of the second stream of bleed air to the turbine of the air cycle machine.

4. The gas turbine engine assembly of claim 3, wherein the bypass valve and the high pressure regulating valve operate independently of each other to adjust a respective flow rate of the first stream of bleed air and the second stream of bleed air.

5. The gas turbine engine assembly of claim 1, wherein a temperature of the combined bleed air stream is lower than a temperature of the second stream of bleed air exiting the high pressure bleed port but of sufficiently high pressure to meet system requirements.

6. The gas turbine engine assembly of claim 1, wherein a mass flow rate of the combined bleed air stream is approximately 2 times greater than the mass flow rate of a single air stream bleed system.

7. The gas turbine engine assembly of claim 1, wherein an electrical motor-generator is mechanically coupled to the shaft of the air cycle machine, the electrical motor-generator configured for either extracting rotational energy from the shaft of the air cycle machine to generate electrical power or supplying a motive force input to the shaft of the air cycle machine.

8. The gas turbine engine assembly of claim 7, further comprising a power storage device, the power storage device being electrically connected to the electrical motor-generator and configured to selectively receive and transmit an electrical power to the electrical motor-generator.

9. The gas turbine engine assembly of claim 1, wherein the accessory system is an environmental control system.

10. The gas turbine engine assembly of claim 1, wherein the junction is selected from a group consisting of an ejector and a mixing manifold.

11. The gas turbine engine assembly of claim 1, wherein the core engine further comprises a fan, the fan being mechanically coupled an electrical motor-generator such that in descent conditions, the fan may drive the electrical motor-generator to generate electrical power.

12. An air cycle machine for extracting bleed air from a gas turbine engine of an aircraft, the gas turbine engine comprising a compressor section, the compressor section defining a low pressure bleed port for extracting a first stream of bleed air and a high pressure bleed port for extracting a second stream of bleed air, the air cycle machine comprising:
a compressor in fluid communication with the low pressure bleed port for receiving a first stream of bleed air and compressing the first stream of bleed air;
a turbine in fluid communication with the high pressure bleed port for receiving a second stream of bleed air and expanding the second stream of bleed air to rotate the turbine;
a shaft mechanically coupling the turbine to the compressor, such that rotation of the turbine drives the compressor; and
a junction in fluid communication with both the compressor and the turbine, the junction being configured to combine the first stream of bleed air from the compressor and the second stream of bleed air from the turbine into a combined bleed air stream to be supplied to an accessory system of the aircraft.

13. The air cycle machine of claim 12, wherein the air cycle machine further comprises:
a bypass bleed line configured for placing the low pressure bleed port in fluid communication with the junction; and
a bypass valve operably coupled to the bypass bleed line, the bypass valve configured to control the flow of the first stream of bleed air through the bypass bleed line to the junction.

14. The air cycle machine of claim 13, wherein the air cycle machine further comprises a high pressure regulating valve operably coupled to the high pressure bleed port, the high pressure regulating valve configured for controlling the flow of the second stream of bleed air to the turbine of the air cycle machine.

15. The air cycle machine of claim 14, wherein the bypass valve and the high pressure regulating valve operate independently of each other to adjust a respective flow rate of the first stream of bleed air and the second stream of bleed air.

16. The air cycle machine of claim 12, wherein a temperature of the combined bleed air stream is lower than a temperature of the second stream of bleed air exiting the high pressure bleed port but of sufficiently high pressure to meet system requirements.

17. The air cycle machine of claim 12, wherein a mass flow rate of the combined bleed air stream is approximately 2 times greater than the mass flow rate of a single air stream bleed system.

18. The air cycle machine of claim 12, further comprising:
an electrical motor-generator, the electrical motor-generator being mechanically coupled to the shaft of the air cycle machine and being configured for either extracting rotational energy from the shaft of the air cycle machine to generate electrical power or supplying a motive force input to the shaft of the air cycle machine; and
a power storage device, the power storage device being electrically connected to the electrical motor-generator and configured to selectively receive and transmit an electrical power to the electrical motor-generator.

19. The air cycle machine of claim 12, wherein the accessory system is an environmental control system.

20. The air cycle machine of claim 12, wherein the junction is selected from a group consisting of an ejector and a mixing manifold.
